(19) United States
(12) Patent Application Publication
(10) Pub. No.: US 2025/0282043 A1
(43) Pub. Date: Sep. 11, 2025

(54) HAMMER HANDLE

(71) Applicant: Daniel J. Raymond, Saginaw, MI (US)

(72) Inventor: Daniel J. Raymond, Saginaw, MI (US)

(21) Appl. No.: 19/075,022

(22) Filed: Mar. 10, 2025

Related U.S. Application Data
(60) Provisional application No. 63/562,899, filed on Mar. 8, 2024.

(51) Int. Cl. B25G 1/10

(52) U.S. Cl. CPC B25G 1/10

(57) ABSTRACT

A hammer including a head having a front portion with a striking face that defines a first plane for driving nails. A notch is spaced apart from the striking face and orientated for pulling a nail in a second plane orthogonal to the first plane. A handle extends from the head and includes a first surface having a contoured profile, a second surface opposite the first surface and having a substantially planar profile, a first portion proximal to the head, and a second portion spaced apart from the first portion, wherein a thickness of the first portion is different from a thickness of the second portion.

### CROSS-REFERENCE TO RELATED APPLICATION

This application claims the benefit of and priority to U.S. Provisional App. No. 63/562,899, filed on Mar. 8, 2024, and entitled “HAMMER HANDLE,” the entire contents of which is herein incorporated by reference.

### BACKGROUND

### 1. Field

The present disclosure is related to a hammer handle that has a variable cross-sectional profile and thickness to optimize strength.

### 2. Related Art

In the construction industry, workers regularly use hammers for various functions related to building framing, shaping and hanging drywall sheets, and removal of nails, studs, and the like. The removal of nails may require use of the hammer as a fulcrum such that a worker applies force to the handle, and the handle must be strong enough to withstand these forces. At the same time, there is a desire to minimize both the mass and the cost of the handle.

### SUMMARY

One aspect of the present disclosure is related to a hammer that includes a head having a front portion with a striking face that defines a first plane for driving nails. The hammer also includes at least one notch spaced apart from the striking face and orientated for pulling a nail in a second plane orthogonal to the first plane. The hammer further includes a handle that extends from the head. The handle includes a first surface that has a contoured profile and a second surface opposite the first surface and that has a substantially planar profile. The handle also has a first end that is proximal to the head and a second end that is spaced apart from the first end. A width of the handle is greater at the first end than it is at the second end.

According to another aspect of the present disclosure, the contoured profile of the first surface includes a pair of outer ridges and a central ridge and valleys that separate the outer ridges from the central ridge.

According to yet another aspect of the present disclosure, the outer ridges have approximately the same thickness along substantially an entire length of the handle.

According to still another aspect of the present disclosure, the central ridge has a varying thickness along a length of the handle.

According to a further aspect of the present disclosure, the handle has a first portion adjacent the head and a second portion adjacent the second end, and wherein the first portion has a constant width along its length.

According to yet a further aspect of the present disclosure, the second portion of the handle has a width that continuously decreases length in a direction towards the second end of the handle.

According to still a further aspect of the present disclosure, a grip surrounds the second portion of the handle.

According to another aspect of the present disclosure, the second portion of the handle has at least one opening and wherein a material of the grip extends through the at least one opening to interconnect the grip with the second portion of the handle.

According to yet another aspect of the present disclosure, a pair of claws extend from the head to distal ends. The distal ends of the claws lie in a common third plane with a lower surface of the front portion of the head. The planar second surface of the handle includes a plurality of angle indicia with lines that point directly towards the distal ends of the claws so that the hammer can be rotated about a pivot point established by the distal ends of the claws to a desired angle so that a line at that angle can be established using the handle as a guide.

According to still another aspect of the present disclosure, the second surface further includes measurement indicia which indicate distance from the common third plane.

According to a further aspect of the present disclosure, the handle is made of metal.

According to yet a further aspect of the present disclosure, the at least one notch is attached to the handle adjacent to the head.

According to still a further aspect of the present disclosure, the at least one notch is integrally formed as part of the head.

Another aspect of the present disclosure is related to a hammer that includes a head with a striking face for driving nails in a first plane. The hammer further includes at least one notch that is spaced apart from the striking face and is orientated for pulling a nail in a second plane that is orthogonal to the first plane. A handle extends from the head to a distal end. The handle has a first surface with a contoured profile and an opposing second surface that is substantially planar. The contoured profile of the first surface including a pair of outer ridges and a center ridge that is positioned between the outer ridges. The outer ridges and the center ridge extending along a majority of a length of the handle.

According to another aspect of the present disclosure, the handle includes a first portion adjacent the head and a second portion adjacent the distal end, and wherein the handle has a reduced width along a full length of the second portion than at any point in the first portion.

According to yet another aspect of the present disclosure, the outer ridges have constant thicknesses along a length of the handle and the center ridge has a varying thickness along the length of the handle.

According to still another aspect of the present disclosure, the center ridge has a first thickness adjacent the head and has a second thickness adjacent the distal end and wherein the second thickness is less than the first thickness.

According to a further aspect of the present disclosure, the head further includes a pair of claws extending from the head to distal ends, the distal ends of the claws lying in a common plane with a lower surface of the front portion of the head. The planar second surface of the handle includes a plurality of angle indicia with lines that point directly towards the distal ends of the claws so that the hammer can be rotated about a pivot point established by the distal ends of the claws to a desired angle so that a line at that angle can be established using the handle as a guide.

Yet another aspect of the present disclosure is related to a hammer that includes a head with a striking face for driving nails and a pair of claws for pulling nails. The hammer further includes at least one notch spaced between the striking face and the claws for pulling nails in a second plane that is orthogonal to the first plane. A handle extends from the head to a distal end. The handle has a first surface with a contoured profile and an opposing second surface that is substantially planar. The contoured profile of the first surface includes a pair of outer ridges and a center ridge that is positioned between the outer ridges. The outer ridges and the center ridge extending along substantially an entire length of the handle.

According to another aspect of the present disclosure, the handle has a first width adjacent the head and has a second width that is less than the first width adjacent the distal end.

### BRIEF DESCRIPTION OF THE DRAWINGS

In the following description, details are set forth to provide an understanding of the present disclosure and are understood not to be limiting. In some instances, certain systems, structures and techniques have not been described or shown in detail in order not to obscure the disclosure. The features previously discussed and other features and advantages of the invention will become more readily appreciated when considered in connection with the following description of the presently preferred exemplary embodiments, appended claims, and accompanying drawings, in which:

FIG. 1 is a perspective view of a hammer constructed according to a first embodiment of the present invention;

FIG. 2 is a front perspective view of the hammer in FIG. 1;

FIG. 3 is a rear perspective view of the hammer in FIG. 1;

FIG. 4 is an elevation view of the hammer in FIG. 1;

FIG. 5 is an elevation view of the hammer in FIG. 1;

FIG. 6 is an elevation view of a schematic drawing of a hammer constructed according to a second embodiment of the present invention;

FIG. 7 is an elevation view of a schematic drawing of the hammer in FIG. 6;

FIG. 8 is an elevation view of a schematic drawing of the hammer in FIG. 6;

FIG. 9 is a cross-sectional perspective of a handle of the hammer in FIG. 6;

FIG. 10 is a cross-sectional perspective of a handle of the hammer in FIG. 6;

FIG. 11A is a cross-sectional view of the hammer taken through line 11A-11A of FIG. 8;

FIG. 11B is a cross-sectional view of the hammer taken through line 11B-11B of FIG. 8;

FIG. 12A is a cross-sectional view of the hammer taken through line 12A-12A of FIG. 8;

FIG. 12B is a cross-sectional view of the hammer taken through line 12B-12B of FIG. 8;

FIG. 13 is an elevation view of a hammer constructed according to a third embodiment of the present disclosure;

FIG. 14 is an elevation view of the hammer in FIG. 13 being used to draw on a surface;

FIG. 15 is an elevation view of the hammer in FIG. 13 being used to draw on a surface;

FIG. 16 is an elevation view of the hammer in FIG. 13 from a different perspective;

FIG. 17 is an elevation view of the hammer in FIG. 13 being used to draw an angle on a surface; and

FIG. 18 is a bottom view of the hammer in FIG. 1 including a slot for receiving a nut or bolt.

### DETAILED DESCRIPTION OF THE ENABLING EMBODIMENTS

Referring to the Figures, wherein like numerals indicate corresponding parts throughout several views, the present disclosure relates to an improved multi-tool device that has the general form of a hammer 20. As discussed in further detail below, the hammer 20 has a number of built-in features that are functional and allow the hammer 20 to perform other functions beyond pounding and pulling nails. These features are incorporated into the hammer 20 in such a way that the basic shape of the hammer 20 remains intact, and thus, the hammer's 20 ability to drive nails is not compromised. In various embodiments discussed below, some (but not all) of the additional functions that the hammer 20 is able to perform include measuring and drawing angles; measuring lengths; locating studs behind a drywall sheet; tightening fasteners; starting nails; and starting fencing staples. As also discussed in further detail below, a handle 24 of the hammer 20 has a unique cross-sectional shape that provides it with exceptional strength and resistance to deformation in two orthogonal directions, thereby allowing the handle 24 to be made with low mass while still being able to resist impact and bending forces when pulling nails with either claws or a side nail puller.

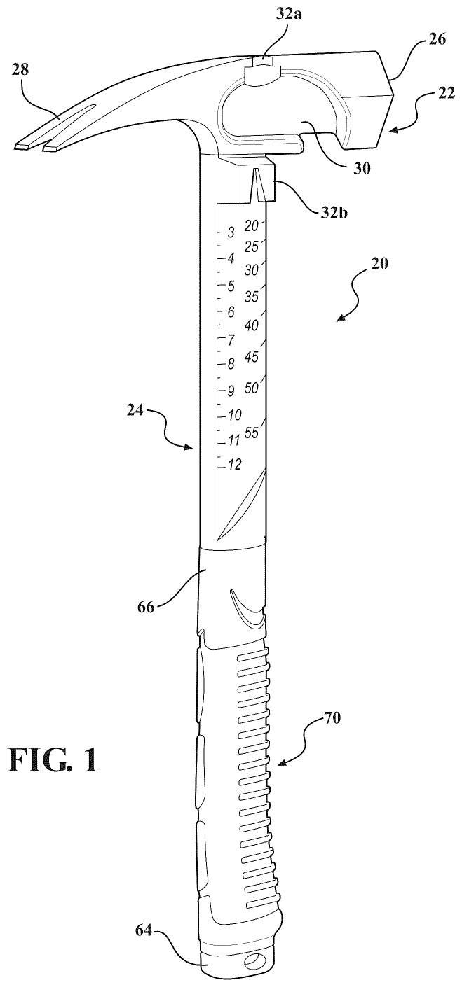

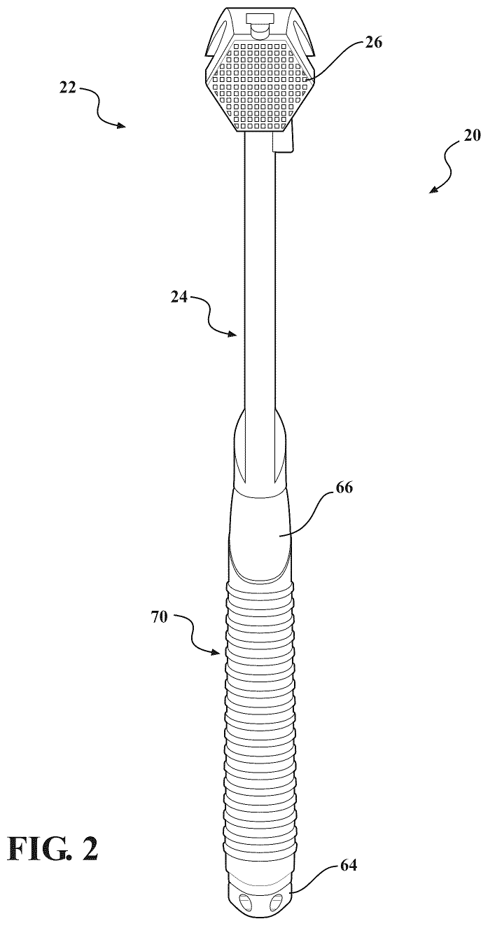

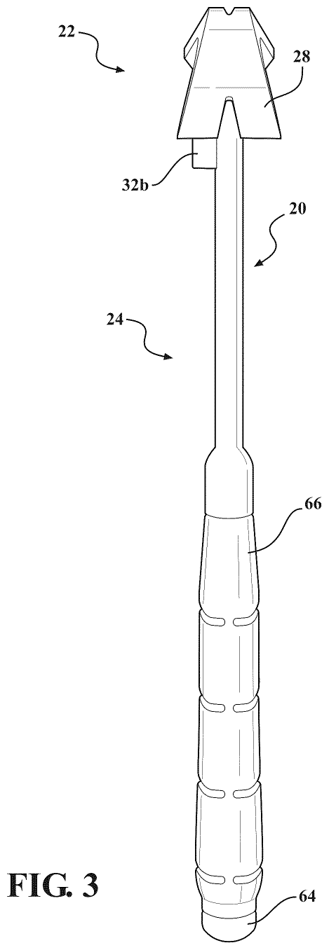

Referring to FIGS. 1-5, a first exemplary embodiment of the hammer 20 is generally shown. The hammer 20 has a head 22 and a handle 24 that extends away from the head 22 in a first direction. The head 22 extends lengthwise in a second direction from a face 26 at one end to a pair of claws 28 at an opposite end. The second direction along which the head 22 extends that is perpendicular to the first direction along which the handle 24 extends. The head 22 has opposing cheeks 30, which lie in respective planes that are parallel with each other and are perpendicular to a plane of the face 26. In the exemplary embodiment, the face 26 has a hexagonal shape and is textured. However, in other embodiments, the face may have alternate shapes, textures, and/or configurations. The claws 28 are spaced apart from one another by a converging groove for receiving and pulling nails. The cheeks 30 may be partially concaved relative to the outer surface of the head 22 to reduce the mass of the head 22. As with conventional hammers, a user can hold and swing the hammer 20 from the handle 24 to drive nails with the face 26 and can pull nails with the claws 28. Thus, the hammer 20 satisfies the basic purpose of a conventional hammer.

The handle 24 can be made of a range of materials, such as wood, a thermosetting polymer matrix (e.g., fiberglass or the like), a metal or metal alloy (e.g., iron, steel, titanium, or the like). The head 22 can also be made of a range of materials, including a metal or metal alloy (e.g., iron, steel, titanium, or the like). The head 22 may be monolithically formed with the handle 24, such as through casting, forging, and/or machining. Alternatively, the head 22 can be attached to the handle 24. In some embodiments, the head 22 is joined with the handle 24 by inserting a portion of the handle 24 into a hole within the head 22 and using wedges, welding, an adhesive, or the like the bind the head 22 and handle 24 together.

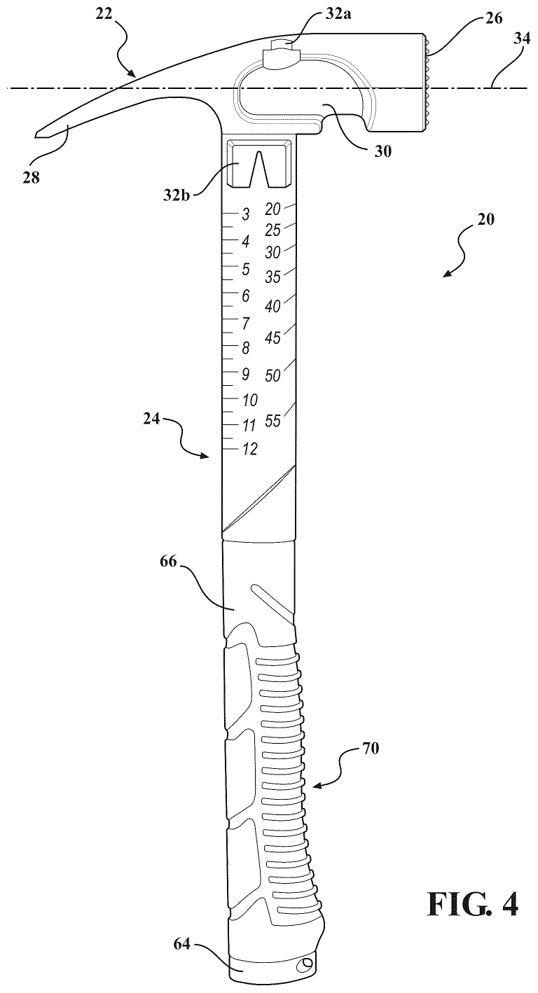

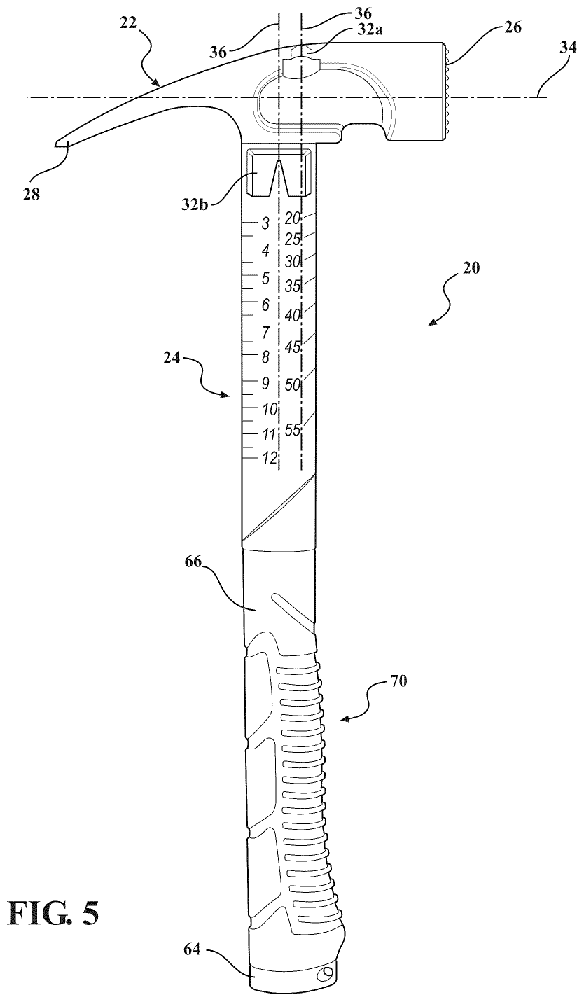

In the first exemplary embodiment, the hammer 20 includes a first nail pulling notch 32a that is located on one side of the head 22, is integrally formed as part of the head 22, and is longitudinally offset from the face 26 in the second direction. The hammer 20 of the first exemplary embodiment also includes a second nail pulling notch 32b that is located on the handle 24 proximal to the head 22 and protrudes outwardly from the handle 24. The second nail pulling notch 32b is cube-shaped with a smooth angular recession. In this embodiment, the second nail pulling notch 32b is integrally formed as part of the handle 24. The nail pulling notches 32a, 32b face in a third direction that is perpendicular to the first and second directions and allow a user to access nails in situations where using the claws 28 would be difficult or impossible. In these situations, the user leverages and stresses the handle 24 in a direction that is orthogonal to the direction in which the handle 24 is stressed when the user swings the hammer 20 to drive a nail with the face 26 or uses the claws 28 to pull a nail. In other words, as shown in FIGS. 4 and 5, the face 26 defines a first plane 34 in which the user may drive a nail and the nail pulling notches 32a, 32b define second planes 36 that are orthogonal to the first plane 34. Thus, the handle experiences a different bending force, or moment, when either of the nail pulling notches 32a, 32b is used as compared to conventional hammer uses, i.e., striking nails with the face or pulling nails with the claws.

In order to maintain structural integrity when using the nail pulling notches 32a, 32b, the handle 24 is shaped to provide it with sufficient strength to resist plastic deformation or fracture when stressed either in a first bending direction during conventional use of the hammer 20 (to strike nails or pull nails with the claws) or in a second bending direction when pulling nails with the nail pulling notches 32a, 32b.

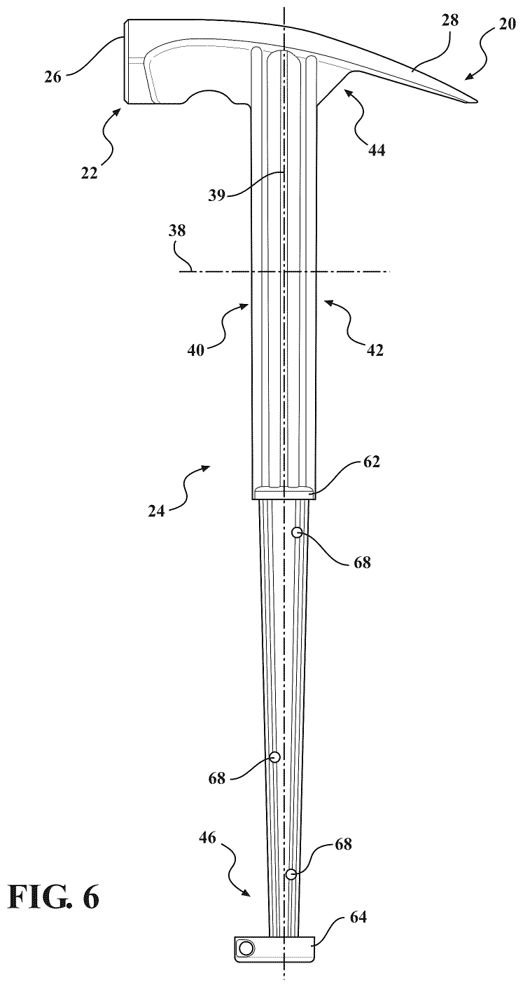

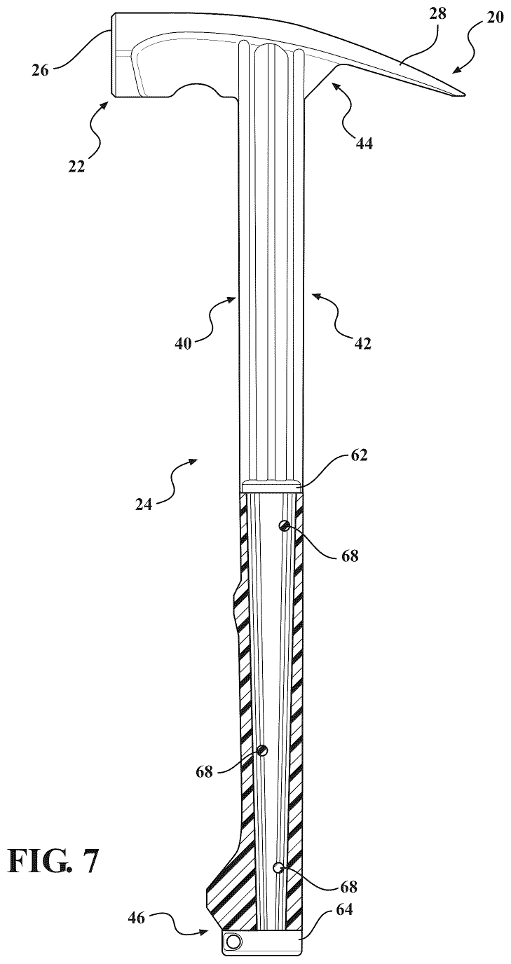

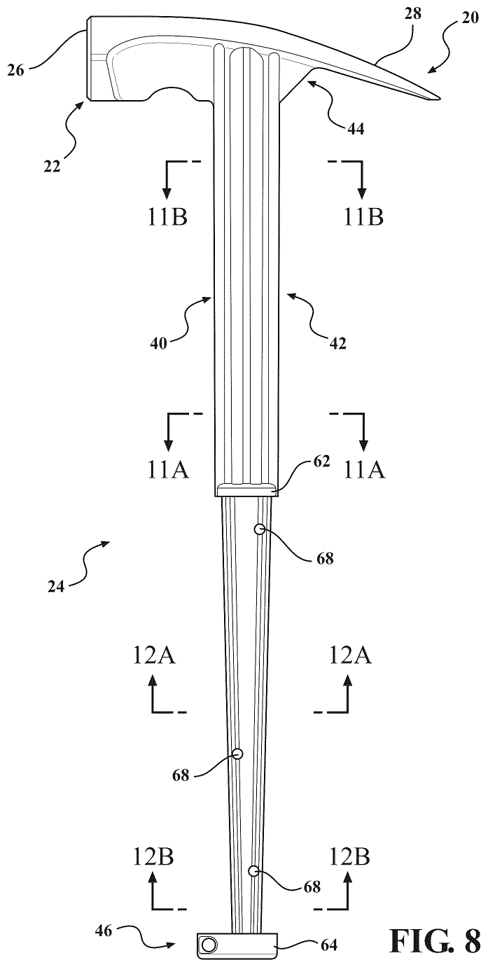

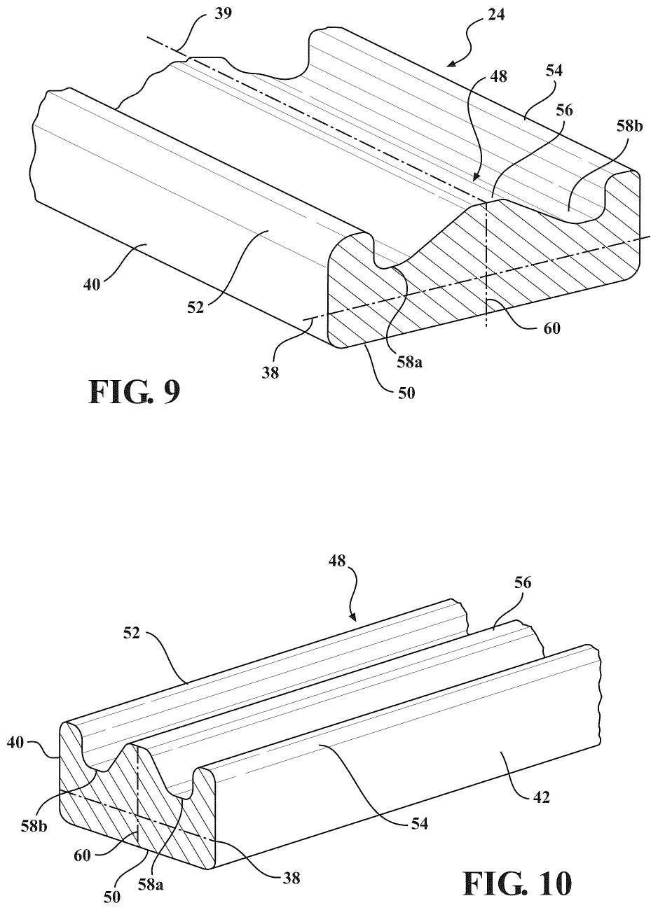

Turning now to FIGS. 6-11, as viewed in cross-section, the handle 24 has a shape that approximates a C-channel but with the addition of the central ridge 56. This cross-sectional shape of the handle 24 is symmetrical about a vertical centerline and includes opposing first and second surfaces 48, 50. The first surface 48 has a contoured surface to reduce the mass of the handle 24 while maintaining its stiffness in the second bending direction. The second surface 50 is substantially flat or planar. The undulations on the first surface 48 include a first outer ridge 52 at one side of the handle 24 and a second outer ridge 54 opposite to the first ridge 52 and at the other side of the handle 24. The first surface 48 further includes a central ridge 56 that is located between the first and second ridges 52, 54, and recessions 58a, 58b are located between the central ridge 56 and the first and second ridges 52, 54 respectively. The ridges 52, 54, 56 and recesses 58a, 58b extend substantially the entire length of the handle 24, i.e., at least 95% of the length 39 between the upper end 44 and the lower end 46.

In the exemplary embodiment, both of the first and second ridges 52, 54 have identical shapes and are rounded along the top and along the sides. Similarly, the top and sides of the central ridge 56 and the bottom and sides of the recessions 58a, 58b are rounded with small planar portions in the exemplary embodiment.

As viewed in cross-section, the handle 24 also has a first side 40 and a second side 42 that together define a lateral width 38 along a lateral axis or the second direction. The lateral width 38 of the handle 24 decreases from the upper end 44 to the lower end 46. More specifically, the lateral width 38 at the upper end 44 is greater than the lateral width at the lower end 46. This decrease in the lateral width 38 also further reduces the cost to produce the handle 24 by requiring less material and reduces the mass of the hammer 20. The resistance to deformation is not compromised by the decrease in lateral width 38 because the inertia of the handle 24 is greatest at the location of maximum stress or moment in the handle 24, which is adjacent the end 44 when the nail pulling notches 32a, 32b are being used. Beyond cost savings, the reduced mass enhances user comfort, increases efficiency, and improves safety.

The decrease in the lateral width 38 from the upper end 44 to the lower end 46 can be gradual or substantial. In the exemplary embodiment, the lateral width 38 is constant from the upper end 44 to a grip attachment point 62 that is approximately halfway between the upper and lower ends 44, 46. Below the grip attachment point 62 the lateral width 38 is markedly reduced (e.g., a step-change or the like) and then tapers continuously in the first direction from the grip attachment point 62 to a base 64 that is located at the lower end 46. The marked reduction in the lateral width 38 provides a space for a grip 66 to be attached to the handle 24 such that the grip 66 can be in line with the outer surface of the handle 24. In the exemplary embodiment, the handle 24 has a constant width of 1.087 inches from the upper end 44 to the grip attachment point 62. Below the grip attachment point 62, in the area of the handle 24 that is hidden within the grip 66, the width tapers continuously to the base 64.

The grip 66 can be composed of any suitable material for providing increased friction between a user's hand and the grip and/or for absorbing vibrations transferred to the user's hand (e.g., rubber, an elastomeric polymer, or the like). In the exemplary embodiments, the handle 24 includes slots 68 or openings or through passages for a grip 66 composed of a polymer to flow through and secure the grip 66 to the handle 24 when the polymer cures during a molding operation. In other words, the slots 68 or through holes allow the grip 66 to be molded in place onto the handle 24 in the area between the grip attachment point 62 and the base 64 to thereby establish an extremely strong and durable connection between the grip 66 and the handle 24. The grip 66 can also include a corrugated surface 70.

The handle 24 also has a transverse thickness 60 on a transverse axis that is defined by the distance between the first surface 48 and the second surface 50. Due to the contoured profile of the first surface 48, the thickness varies across the handle from one side 40 of the handle to the other side 42. One benefit of the varying transverse thickness 60 is that less material is required to produce the handle 24 as compared to a traditional rectangular shape without compromising the strength of the handle 24 when the nail pulling notches 32a, 32b are being used. In other words, a user can use either of the nail pulling notches 32a, 32b and apply force to the handle 24 without risk that the handle 24 will bend or break. The reduced amount of material used in making this shape both reduces the cost to manufacture the handle 24 and also makes the hammer 20 less massive, thereby making it easier to swing and use. The thickness 60 of the handle is maximum in the areas of the first and second ridges 52, 54. In other words, the central ridge 56 does not rise as far from the second surface 50 as the first and second ridges 52, 54 do.

The dimensions of the first and second ridges 52, 54, the central ridge 56, and the recessions 58a, 58b may be different depending on the various portions, segments, or cross-sections of the handle 24 from the upper end 44 to the lower end 46. For example, changes in the lateral width 38 can affect the width of the first and second ridges 52, 54, the central ridge 56, and/or the recessions 58a, 58b such that the contoured profile of the first surface 48 may be more or less rounded, angular, or the like. That is, while the same general shape with the contoured first surface 48 that has the ridges 52, 54, 56 and the flat second surface 50 remains the same, the relative dimensions of these features may change along the length of the handle 24.

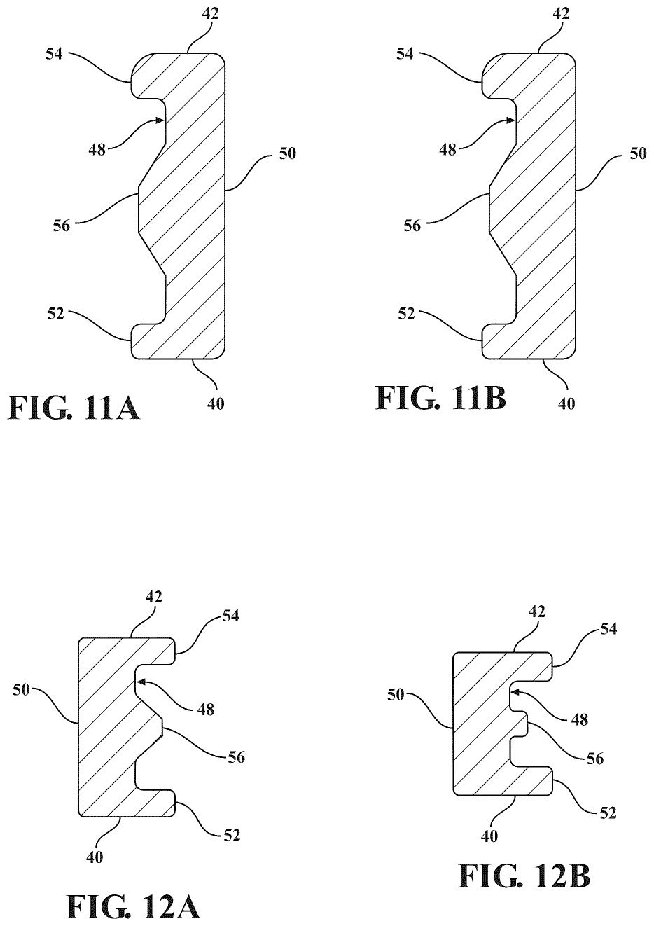

In the exemplary embodiment, the transverse thickness 60 of the handle varies along the length of the handle 24 in some locations, such as at the central ridge 56, but is constant at other locations, such as at the first and second ridges 52, 54. More specifically, the maximum transverse thickness 60 at the first and second ridges 52, 54 is approximately 0.335 inches along substantially the entire length of the handle 24 from the upper end 44 to the lower end 46. However, in the region of the central ridge 56, the thickness 60 gradually decreases from 0.328 inches at the location of FIG. 8D, which is adjacent the upper end 44 to 0.195 inches at the location of FIG. 8E, which is adjacent the lower end 46. FIGS. 11A, 11B, 12A, and 12B show specific dimensions of the first and second edges 52, 54, the central ridge 56, and the recessions 58a, 58b at various locations along the length of the handle 24.

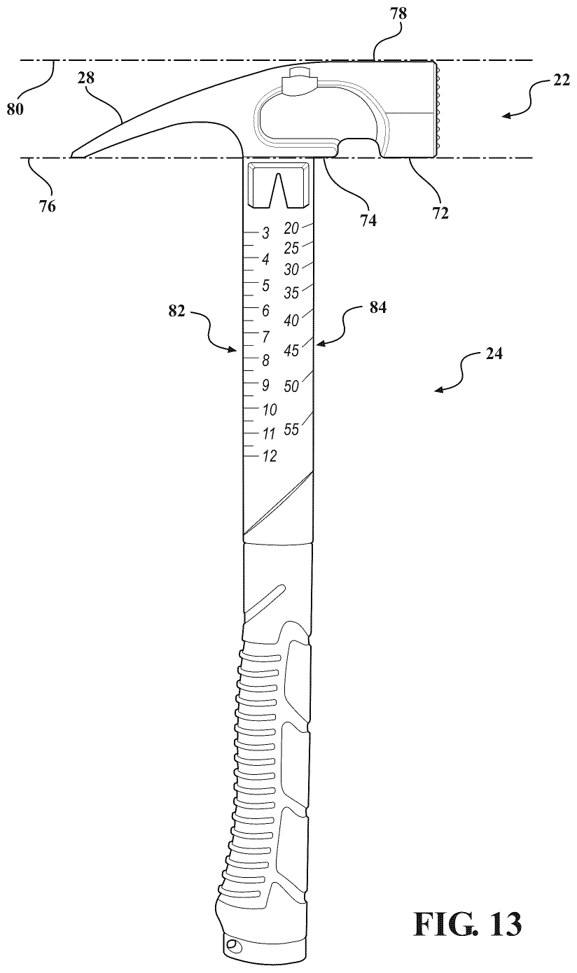

The hammer 20 can also be used to draw lines, measure lengths, and measure angles. With reference to FIGS. 13-17, to perform this function the head 22 has at least two (three in the third exemplary embodiment) co-planar features. Specifically, in the head 22, the three co-planar surfaces area include a lower surface 72 of a front area adjacent to the face 26, a shoulder 74 adjacent to where the head 22 connects to the handle 24, and the distal ends of the claws 28. In other words, all three of these features (the lower surface 72, the shoulder 74, and the ends of the claws 28) lie in a common third plane 76. Optionally, an uppermost surface 78 of the head 22 may extend linearly in a fourth plane 80 that is parallel to the third plane 76. At least one side surface at the first or second ends 40, 42 of the handle 24 and extends linearly from the head 22 and perpendicular to the third plane 76 for a certain distance. In the third exemplary embodiment, both the side surfaces of the handle at the first and second ends 40, 42 are parallel with one another such that both side surfaces extend linearly from the head 22 and perpendicular to the third plane 76.

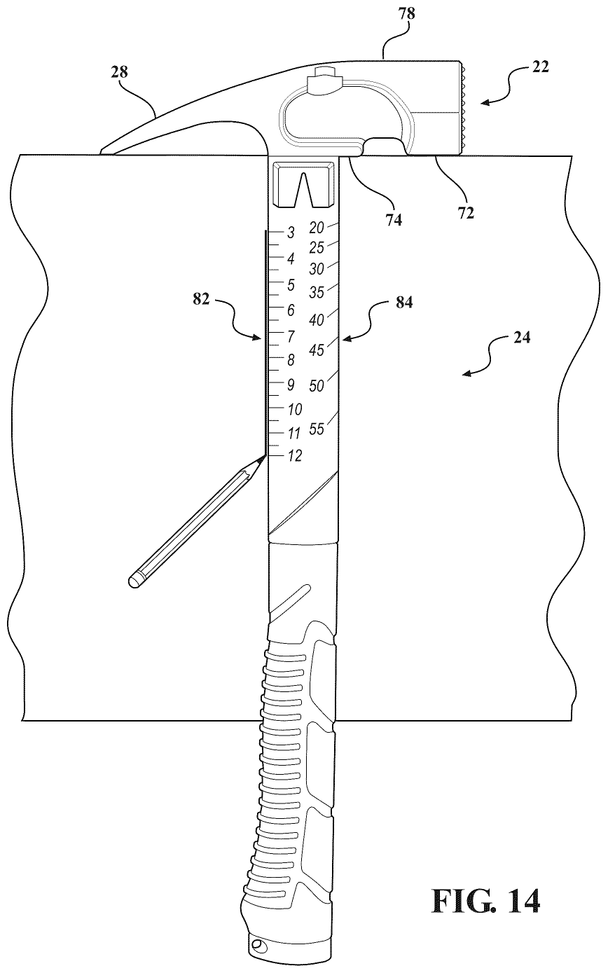

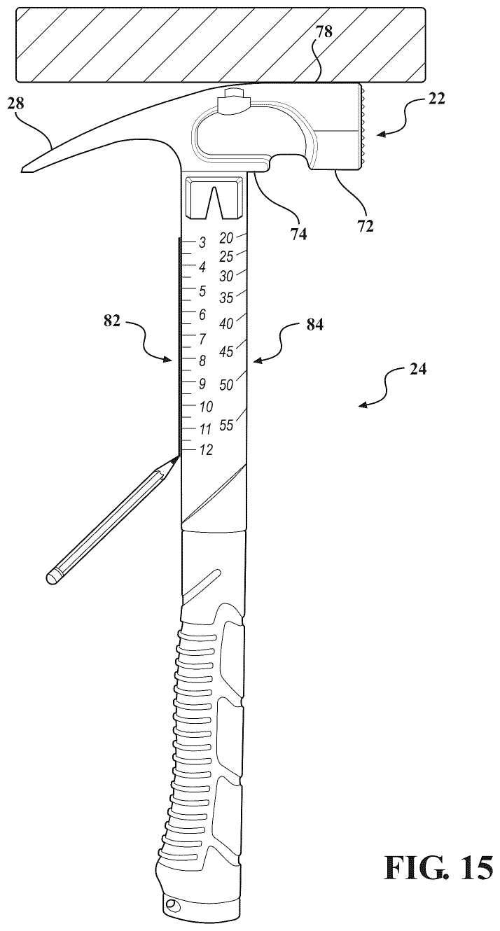

Thus, as shown in FIG. 14, one method of drawing a perpendicular line involves the user placing all three of the co-planar surfaces (the lower surface 72, the shoulder 74, and the ends of the claws 28) against a measuring surface, such as on a wood board or the like. The user then uses the linear side surface on the handle 24 as a straight edge to draw a line on the wood board with a writing utensil. As shown in FIG. 15, an alternate method of drawing a perpendicular line involves the user butting the uppermost surface 78 against a top surface and using the linear side surface of the handle 24 as a straight edge to draw a line on the wood board.

As shown in FIGS. 13-15 the second surface 50 of the handle 24 can include measurement indicia 82. Accordingly, the hammer 20 can be used as a ruler by placing all three co-planar surfaces against a measuring surface and using the measuring indicia 82 to measure a distance on the measuring surface. The measuring indicia 82 may include measuring units from a variety of measuring systems such as inches, centimeters, or the like, or a combination or sub-combination thereof.

The hammer 20 can also be used to conveniently and easily measure and draw desired angles other than ninety degree onto objects, such as drywall sheets or wood boards. Referring to FIG. 13, the second surface 50 of the handle 24 can include angle indicia 84, in combination with or separate from the measuring indicia 82. The angle indicia 84 includes a plurality lines that all point directly to the distal ends of the claws 28 and that indicate respective angles from the ends of the claws 28 relative to the third plane 76.

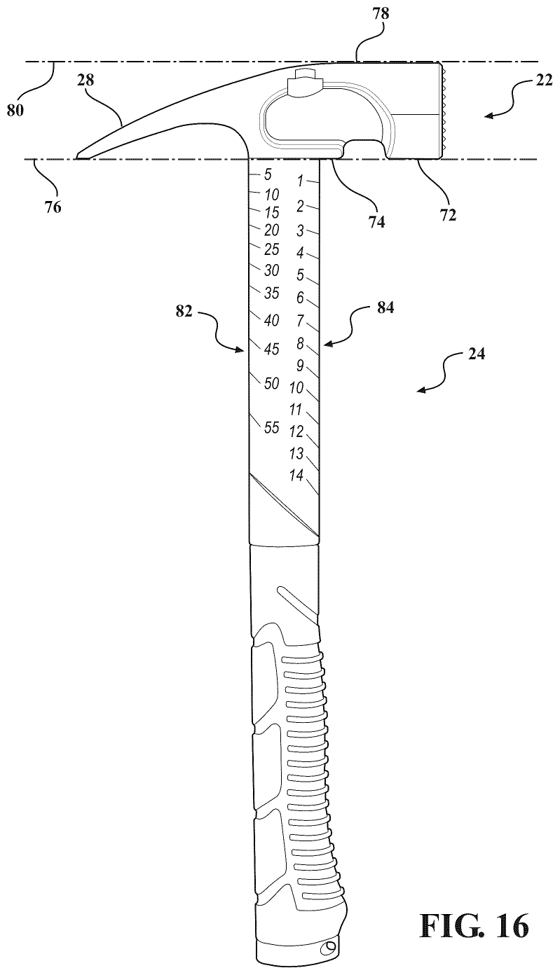

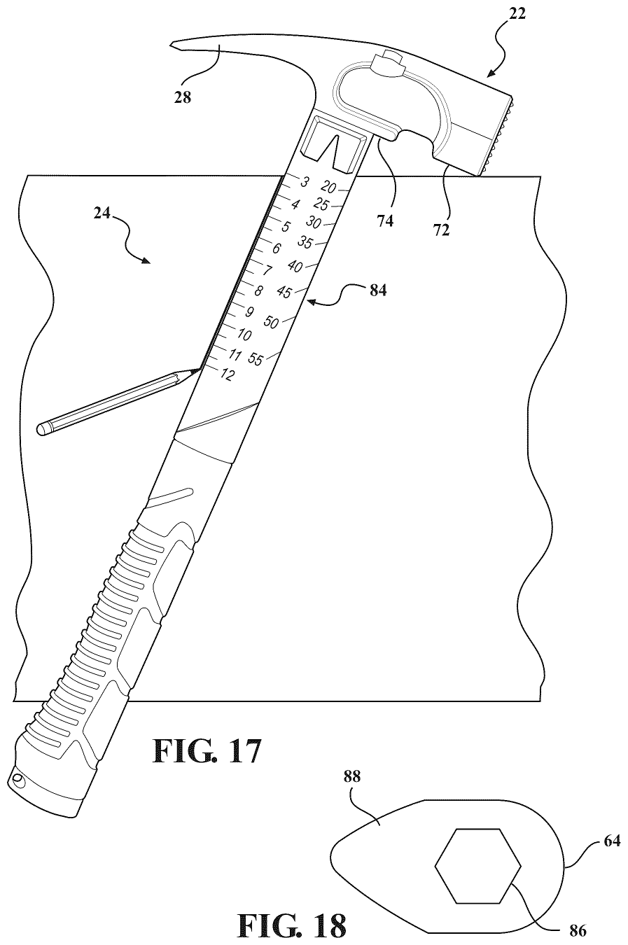

The angle indicia 84 may include measuring units from a variety of measuring systems such as degrees, common cuts measured in rise over run ratios that are common in the building construction industry, or the like. Referring to FIG. 16, in the third exemplary embodiment, the handle 24 is provided with two different sets of angle indicia 84. One set of angle indicia 84 is measure in units of degrees and the other set is common cut ratios with the run being fixed at 12. For example, the common cuts angle indicia 84 includes markings that correspond to 1:12 to 14:12 common cuts. As shown in FIG. 17, to draw an angled line, first the user places the three co-planar surfaces of the head 22 against a measuring surface. Next, the user pivots the hammer 20 about the ends of the claws 28 until the measuring surface is aligned with a desired angle indicia 84. The user then holds the hammer 20 at this particular orientation and traces along the linear portion of the handle 24 to draw a straight line onto the measuring surface at the desired angle. An angle can be measured by a similar process.

As shown in FIG. 18, the base 64 of the handle 24 includes a slot 86 for receiving a nut or bolt. The slot 86 is disposed on a bottom surface 88 of the base 64. The slot 86 is recessed into the handle 24 such that it has a depth that is suitable for fully covering the nut. The slot 86 is also shaped to match the shape of the nut such that when the nut is within the slot 86 the handle 24 can be rotated to apply torque to the nut and rotate the nut. In particular, the slot 86 may be shaped to match a 13 mm nut or bolt (e.g., the slot 86 may have a hexagonal shape configured to match the hexagonal shape of a 13 mm nut or bolt). The slot 86 may also include other shapes such as circles, squares, rectangles, other sided polygons, or the like. In some embodiments, the slot 86 is configured to receive a nut for controlling a safety feature of a machine such as a saw mill wherein rotation of the handle 24 causes the nut to rotate and activate or deactivate the safety feature based on the angle of rotation.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. Additionally, it is to be understood that all features of all claims and all embodiments can be combined with each other as long as they do not contradict each other. Further, it is to be understood that certain terms of direction, such as upper, lower, top, bottom, side, are in reference to the orientation of the hammer as shown in FIG. 1 and are not intended to be limiting.

What is claimed is:

1. A hammer, comprising:
a head having a front portion with a striking face that defines a first plane for driving nails;
at least one notch spaced apart from the striking face and orientated for pulling a nail in a second plane orthogonal to the first plane; and
a handle extending from the head, the handle including:
a first surface having a contoured profile,
a second surface opposite the first surface and having a substantially planar profile,
a first end proximal to the head,
a second end spaced apart from the first end, and
wherein a width of the handle is greater at the first end than it is at the second end.

2. The hammer as set forth in claim 1, wherein the contoured profile of the first surface includes a pair of outer ridges and a central ridge and valleys that separate the outer ridges from the central ridge.

3. The hammer as set forth in claim 2, wherein the outer ridges have approximately the same thickness along substantially an entire length of the handle.

4. The hammer as set forth in claim 3, wherein the central ridge has a varying thickness along a length of the handle.

5. The hammer as set forth in claim 1, wherein the handle has a first portion adjacent the head and a second portion adjacent the second end, and wherein the first portion has a constant width along its length.

6. The hammer as set forth in claim 5, wherein the second portion of the handle has a width that continuously decreases length in a direction towards the second end of the handle.

7. The hammer as set forth in claim 6, further including a grip that surrounds the second portion of the handle.

8. The hammer as set forth in claim 7, wherein the second portion of the handle has at least one opening and wherein a material of the grip extends through the at least one opening to interconnect the grip with the second portion of the handle.

9. The hammer as set forth in claim 1 further comprising:
a pair of claws extending from the head to distal ends, the distal ends of the claws lying in a common third plane with a lower surface of the front portion of the head; and
wherein the planar second surface of the handle includes a plurality of angle indicia with lines that point directly towards the distal ends of the claws so that the hammer can be rotated about a pivot point established by the distal ends of the claws to a desired angle so that a line at that angle can be established using the handle as a guide.

10. The hammer as set forth in claim 9 wherein the second surface further includes measurement indicia which indicate distance from the common third plane.

11. The hammer as set forth in claim 1 wherein the handle is made of metal.

12. The hammer as set forth in claim 1 wherein the at least one notch is attached to the handle adjacent to the head.

13. The hammer as set forth in claim 1 wherein the at least one notch is integrally formed as part of the head.

14. A hammer, comprising:
a head with a striking face for driving nails in a first plane;
at least one notch spaced apart from the striking face and orientated for pulling a nail in a second plane that is orthogonal to the first plane;
a handle extending from the head to a distal end;
the handle having a first surface with a contoured profile and an opposing second surface that is substantially planar; and
the contoured profile of the first surface including a pair of outer ridges and a center ridge that is positioned between the outer ridges, the outer ridges and the center ridge extending along a majority of a length of the handle.

15. The hammer as set forth in claim 14, wherein the handle includes a first portion adjacent the head and a second portion adjacent the distal end, and wherein the handle has a reduced width along a full length of the second portion than at any point in the first portion.

16. The hammer as set forth in claim 15 wherein the outer ridges have constant thicknesses along a length of the handle and the center ridge has a varying thickness along the length of the handle.

17. The hammer as set forth in claim 16, wherein the center ridge has a first thickness adjacent the head and has a second thickness adjacent the distal end and wherein the second thickness is less than the first thickness.

18. The hammer as set forth in claim 14, wherein the head further includes a pair of claws extending from the head to distal ends, the distal ends of the claws lying in a common plane with a lower surface of the front portion of the head; and
wherein the planar second surface of the handle includes a plurality of angle indicia with lines that point directly towards the distal ends of the claws so that the hammer can be rotated about a pivot point established by the distal ends of the claws to a desired angle so that a line at that angle can be established using the handle as a guide.

19. A hammer, comprising:
a head with a striking face for driving nails and a pair of claws for pulling nails;
at least one notch spaced between the striking face and the claws for pulling nails in a second plane that is orthogonal to the first plane;
a handle extending from the head to a distal end;
the handle having a first surface with a contoured profile and an opposing second surface that is substantially planar; and
the contoured profile of the first surface including a pair of outer ridges and a center ridge that is positioned between the outer ridges, the outer ridges and the center ridge extending along substantially an entire length of the handle.

20. The hammer as set forth in claim 19, wherein the handle has a first width adjacent the head and a second width that is less than the first width adjacent the distal end.
